(19) United States
(12) Patent Application Publication
(10) Pub. No.: US 2019/0299313 A1
(43) Pub. Date: Oct. 3, 2019

(54) SOLDERING APPARATUS

(71) Applicant: DENSO TEN Limited, Kobe-shi (JP)

(72) Inventor: Hisaki HAYASHI, Kobe-shi (JP)

(73) Assignee: DENSO TEN Limited, Kobe-shi (JP)

(21) Appl. No.: 16/207,607

(22) Filed: Dec. 3, 2018

(30) Foreign Application Priority Data
Mar. 27, 2018 (JP) 2018-060494

(51) Int. Cl. B23K 3/06

(52) U.S. Cl. CPC B23K 3/0653

(57) ABSTRACT

A soldering apparatus includes a solder bath, an ejection nozzle and a solder flow slowing ramp. The solder bath is configured to hold molten solder. The ejection nozzle ejects the molten solder supplied from the solder bath. The solder flow slowing ramp i) is disposed adjacent to an outlet of the ejection nozzle and receives the molten solder overflowing from the ejection nozzle, and ii) downwardly slopes toward a liquefied solder surface of the molten solder in the solder bath so as to return the molten solder overflowing from the ejection nozzle to the solder bath.

### BACKGROUND OF THE INVENTION

### Field of the Invention

The invention relates to a solder flow slowing apparatus.

### Description of the Background Art

Conventionally, there has been a type of jet flow soldering apparatuses that returns, to a solder bath, molten solder ejected from a jet flow nozzle. Such a jet flow soldering apparatus returns the solder and reuses the returned solder.

However, in the conventional technology, while the molten solder is being returned, oxygen in the air is taken into the solder bath. Thus, dross that is an oxide of solder is generated. Therefore, the dross needs to be regularly removed.

### SUMMARY OF THE INVENTION

According to one aspect of the invention, a soldering apparatus includes: a solder bath configured to hold molten solder; an ejection nozzle that ejects the molten solder supplied from the solder bath; and a solder flow slowing ramp that i) is disposed adjacent to an outlet of the ejection nozzle and receives the molten solder overflowing from the ejection nozzle, and ii) downwardly slopes toward a liquefied solder surface of the molten solder in the solder bath so as to return the molten solder overflowing from the ejection nozzle to the solder bath.

Thus, it is possible to curb generation of dross.

According to another aspect of the invention, a base end portion of the ramp is rotatably attached to the ejection nozzle and rotates about a rotation axis that is parallel to the liquefied solder surface of the molten solder in the solder bath. A tip end portion of the ramp is configured to float on the liquefied solder surface of the molten solder in the solder bath.

Thus, the tip end portion of the ramp moves up and down in accordance with the liquefied solder surface of the molten solder, and is kept floating on the liquefied solder surface of the molten solder.

Therefore, an object of the invention is to curb generation of dross.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 illustrates an outline of a soldering apparatus;

FIG. 2 is a perspective view of the solder flow slowing apparatus;

FIG. 3 illustrates a catchment;

FIG. 4A illustrates a relationship between the solder flow slowing apparatus and a liquefied solder surface of the molten solder in a solder bath; and

FIG. 4B illustrates another relationship between the solder flow slowing apparatus and the liquefied solder surface of the molten solder in the solder bath.

### DESCRIPTION OF THE EMBODIMENTS

A soldering apparatus, especially a solder flow slowing apparatus included in the solder apparatus of this embodiment will be described below in detail, with reference to the attached drawings. This embodiment is not intended to limit the invention in any way.

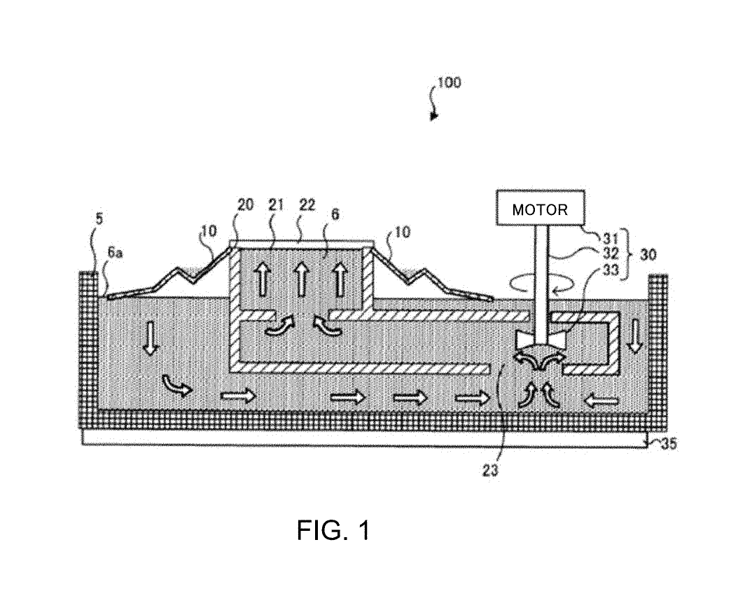

First, an outline of this solder flow slowing apparatus of this embodiment will be described with reference to FIG. 1. FIG. 1 illustrates the outline of the solder flow slowing apparatus. As shown in FIG. 1, a solder flow slowing apparatus 10 is installed to a soldering apparatus 100.

The soldering apparatus 100 is a jet flow soldering apparatus, and includes: a solder bath 5 that holds molten solder 6; and a jet nozzle 20 that ejects vertically upward the molten solder 6 drawn by a pump 30 that draws the molten solder 6 from the solder bath 5.

Moreover, a heater 35 is provided to a bottom surface of the solder bath 5. The heater 35 heats and melts solder in the solder bath 5, and then maintains the molten solder 6 at a temperature that is proper to soldering.

The solder bath 5 includes a drawing aperture 23 that takes in and returns the molten solder 6 ejected from the jet nozzle 20. The molten solder 6 taken from the drawing aperture 23 is pneumatically sent to the jet nozzle 20.

The pump 30 includes a motor 31, a rotation shaft 32 and an impeller 33. The pump 30 drives the rotation shaft 32 that is coupled to the motor 31 to rotate the impeller 33. The pump 30 takes up the molten solder 6 in the solder bath 5 from the drawing aperture 23, by a rotative force of the impeller 33, as shown by arrows in FIG. 1, and then sends the molten solder 6 to the jet nozzle 20 under pressure.

Thus, the molten solder 6 is ejected vertically upward from the jet nozzle 20. Moreover, the soldering apparatus 100 applies a portion of the molten solder 6 ejected from the jet nozzle 20 for soldering, for example, to connection portions of a printed circuit board placed on an upper surface of a pallet. Remaining molten solder 6 that was not used for soldering of the printed circuit board overflows from the jet nozzle 20, and is led to the solder bath 5.

When using a conventional technology, there has been a case in which molten solder vigorously drops to a solder bath from an ejection nozzle. In such a case, a surface of a liquid (solder) in the solder bath is disturbed and air is sent into an inside of the molten solder in the solder bath.

The molten solder is oxidized in the solder bath so that dross, oxides of the molten solder, is generated in the solder bath. An operator needs to regularly remove the dross from the solder bath. It is not easy to remove the dross that is generated in the solder bath, and it is a time consuming work. Moreover, if the dross is not removed and is left, the dross may be a cause of failure of the soldering apparatus 100.

Then, the solder flow slowing apparatus 10 of this embodiment slows the molten solder 6 overflowing from the jet nozzle 20, and then sends the molten solder 6 back to a liquefied solder surface 6a of the molten solder in the solder bath 5. More specifically, the solder flow slowing apparatus 10 downwardly slopes from an aperture 21 of the jet nozzle 20 toward the liquefied solder surface of the molten solder in the solder bath 5.

The solder flow slowing apparatus 10 may be formed as one unit with the jet nozzle 20, or may be installed to the jet nozzle 20 later. Moreover, the solder flow slowing apparatus 10 is installed to a rim of the aperture 21 of the jet nozzle 20. However, the solder flow slowing apparatus 10 may be installed to an arbitrary location of a side wall of the jet nozzle 20.

In order to lead the molten solder 6 to the solder flow slowing apparatus 10, the jet nozzle 20 includes a guard wall 22 that is provided to a portion of the rim of the aperture 21 to which the solder flow slowing apparatus 10 is not installed. The molten solder 6 is led to the solder flow slowing apparatus 10 by the guard wall 22.

The molten solder 6 overflowing from the jet nozzle 20 is slowed by the solder flow slowing apparatus 10, and then joins the liquefied solder surface 6a of the molten solder in the solder bath 5. Thus, the molten solder 6 is returned to the solder bath 5 without disturbing the liquefied solder surface 6a of the molten solder in the solder bath 5.

Therefore, according to the solder flow slowing apparatus 10 of this embodiment, it is possible to curb generation of the dross in the solder bath 5 because air is not mixed into the molten solder 6 in the solder bath 5. Moreover, since the generation of the dross in the solder bath 5 is curbed, easy and less frequent cleaning work is possible for the operator.

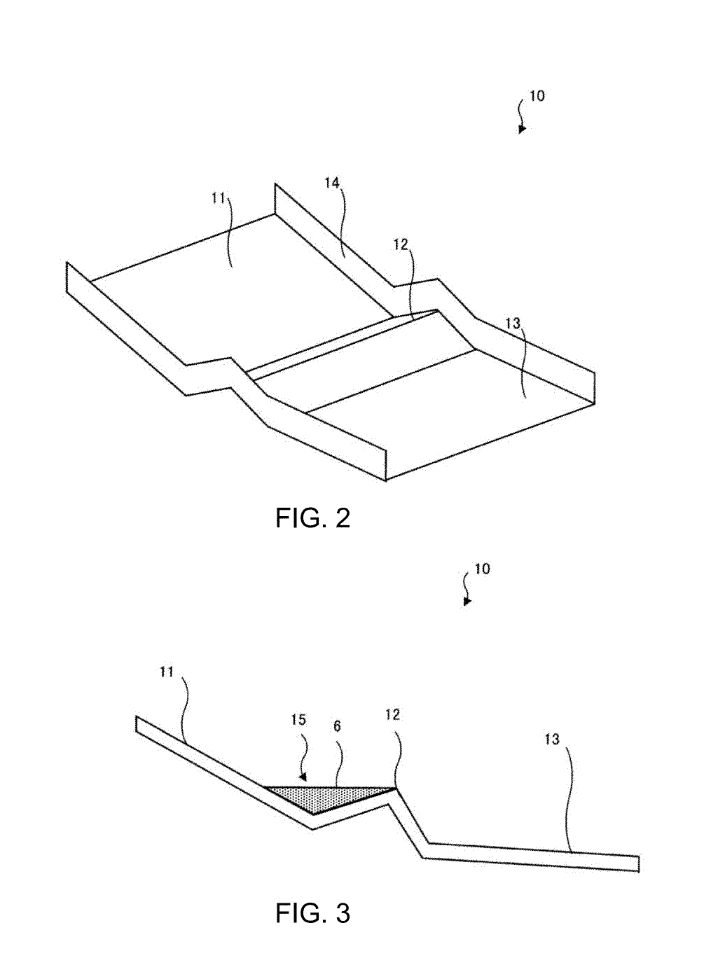

Next, a structural example of the solder flow slowing apparatus 10 will be described with reference to FIG. 2. FIG. 2 is a perspective view of the solder flow slowing apparatus 10. The solder flow slowing apparatus 10 is formed, for example, by bending one metal plate. As shown in FIG. 2, the solder flow slowing apparatus 10 includes an upper slope 11, a step 12, a lower slope 13 and side walls 14. The upper slope 11, the step 12 and the lower slope 13 may be referred to collectively as a ramp.

In a state in which the solder flow slowing apparatus 10 is attached, the upper slope 11 includes a downward slope portion. The upper slope 11 is provided, for example, to the rim of the aperture 21 of the jet nozzle 20 described above. The upper slope 11 receives the molten solder 6 overflowing from the jet nozzle 20. The molten solder 6 flows on the upper slope 11 and flows down to the step 12.

The step 12 includes an upward slope portion while the upper slope 11 includes the downward slope portion. Thus, after the molten solder 6 passes the upper slope 11, the molten solder 6 is slowed down by the step 12. In other words, a catchment 15, described later with reference to FIG. 3, is formed by the step 12.

Moreover, after the molten solder 6 passes the step 12, the molten solder 6 flows into the solder bath 5 via the lower slope 13. The side walls 14 prevent the molten solder 6 from departing from the solder flow slowing apparatus 10 in middle of travelling to the solder bath 5.

Next, the catchment 15 will be described with reference to FIG. 3. FIG. 3 illustrates the catchment 15. As shown in FIG. 3, at first, the molten solder 6 that flows down from the upper slope 11 cannot pass over the step 12. The molten solder 6 pools on an upper side of the step 12 so that the catchment 15 of the molten solder 6 is formed.

Then, the molten solder 6 that continuously flows down from the upper slope 11 is slowed down by the molten solder 6 in the catchment 15. In other words, the molten solder 6 in the catchment 15 serves as a buffer that slows the molten solder 6 that newly flows into the catchment 15.

Then, the molten solder 6 slowed down flows down into the solder bath 5 via the lower slope 13 after passing the step 12.

As described above, since the solder flow slowing apparatus 10 of this embodiment includes the catchment 15, the solder flow slowing apparatus 10 absorbs potential energy of the molten solder 6 flowing from the upper slope 11, by the molten solder 6 in the catchment 15.

Therefore, according to the solder flow slowing apparatus 10 of this embodiment, the molten solder 6 can be effectively slowed down. Moreover, since the solder flow slowing apparatus 10 has a simple structure, as described above, the solder flow slowing apparatus 10 is easily cleaned.

Here, the liquefied solder surface 6a of the molten solder in the solder bath 5 constantly changes. For example, when an amount of the molten solder 6 decreases in the solder bath 5, the liquefied solder surface 6a of the molten solder lowers. When the amount of the molten solder 6 increases in the solder bath 5, the liquefied solder surface 6a of the molten solder rises.

Especially, as the liquefied solder surface 6a of the molten solder lowers further, a distance between the liquefied solder surface 6a of the molten solder and the aperture 21 of the jet nozzle 20 (see FIG. 1) becomes greater. In other words, as the liquefied solder surface 6a of the molten solder lowers further, the potential energy of the molten solder 6 overflowing from the jet nozzle 20 becomes greater so that a flowing speed of the molten solder 6 becomes greater.

Therefore, a base end portion (an upper side) of the solder flow slowing apparatus 10 of this embodiment is slidably attached, and a tip end portion of the solder flow slowing apparatus 10 is configured to float on the liquefied solder surface 6a of the molten solder (a lower side).

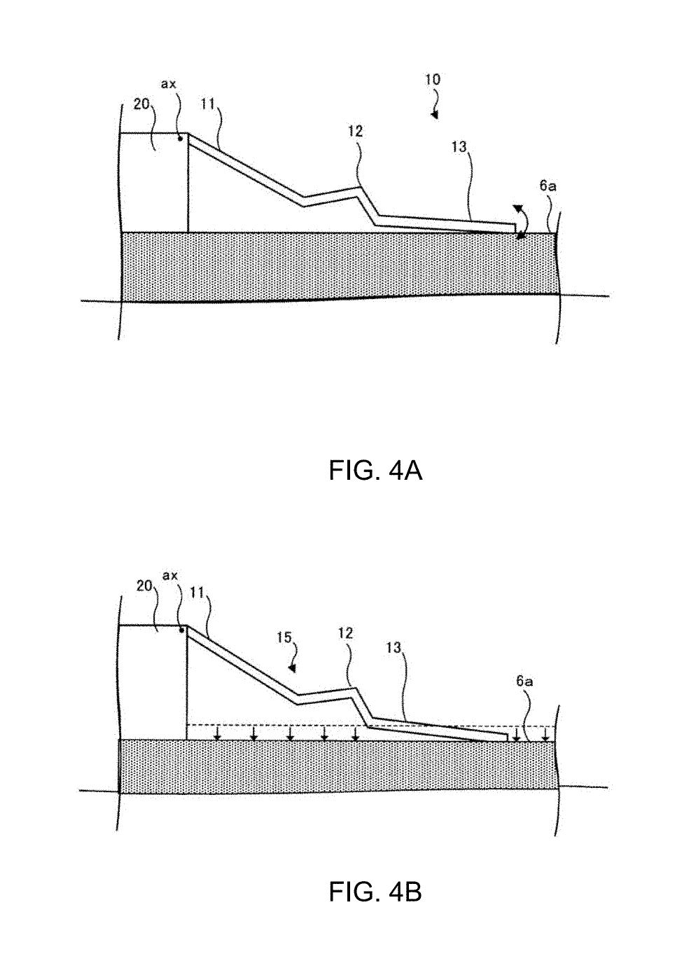

FIGS. 4A and 4B illustrate relationships between the solder flow slowing apparatus 10 and the liquefied solder surface 6a of the molten solder. As shown in FIG. 4A, the solder flow slowing apparatus 10 is rotatably attached to the jet nozzle 20 and rotates about a rotation axis ax that is parallel to the liquefied solder surface 6a of the molten solder, and the tip end portion (a side of the lower slope 13) of the solder flow slowing apparatus 10 is configured to float on the liquefied solder surface 6a of the molten solder.

In other words, the solder flow slowing apparatus 10 is attached such that the tip end portion moves up and down depending on the liquefied solder surface 6a of the molten solder in the solder bath 5. Therefore, as shown in FIG. 4B, even in a case where the liquefied solder surface 6a of the molten solder in the solder bath 5 lowers, the solder flow slowing apparatus 10 keeps the tip end portion floating on the liquefied solder surface 6a of the molten solder. Thus, the tip end portion of the solder flow slowing apparatus 10 moves in accordance with the liquefied solder surface 6a of the molten solder.

As a result, the solder flow slowing apparatus 10 of this embodiment sufficiently slows and leads the molten solder 6 to the liquefied solder surface 6a of the molten solder in the solder bath, 5 regardless of fluctuation of the liquefied solder surface 6a of the molten solder. In other words, even if the liquefied solder surface 6a of the molten solder rises or lowers, the solder flow slowing apparatus 10 slows the molten solder 6 stably.

Here, the solder flow slowing apparatus 10 is made from a material that is lighter than the molten solder 6 in terms of specific weight, in order to float on the liquefied solder surface 6a of the molten solder. For example, such a material is titanium. Titanium has a light specific weight and high heat conductivity. Thus, a temperature of the solder flow slowing apparatus 10 can be maintained at a similar temperature of the molten solder 6 in the solder bath 5.

Thus, while preventing the temperature of the molten solder 6 from lowering during travelling the solder flow slowing apparatus 10, the solder flow slowing apparatus 10 of this embodiment returns the molten solder 6 to the solder bath 5. Therefore, it is possible to prevent the temperature of the molten solder 6 from falling below a melting point and being solidified during travelling the solder flow slowing apparatus 10.

In this embodiment, the tip end portion of the solder flow slowing apparatus 10 floats on the liquefied solder surface 6a of the molten solder in the solder bath 5 by use of a material lighter than the specific weight of the molten solder 6, for the solder flow slowing apparatus 10. However, a floating method is not limited to that. In other words, a buoyancy part having a buoyant force is provided to the tip end portion to float the tip end portion on the liquefied solder surface 6a of the molten solder in the solder bath 5 by the buoyant force of the buoyancy part.

In such a case, the solder flow slowing apparatus 10 stably serves to slow the molten solder 6, regardless of the fluctuation of the liquefied solder surface 6a of the molten solder in the solder bath 5. Any form and configuration of the buoyancy part is possible only if the member is heat resistant and has a buoyant force great enough to float the tip end portion of the solder flow slowing apparatus 10.

Moreover, the foregoing embodiment describes the case in which the solder flow slowing apparatus 10 is rotatably attached so as to rotate about the jet nozzle 20. However, the solder flow slowing apparatus 10 is not limited to that case. In other words, the solder flow slowing apparatus 10 may have the rotation axis ax in a midway position of the solder flow slowing apparatus 10. Moreover, the lower slope 13 of the solder flow slowing apparatus 10 may be made from a soft material, and the rotation axis ax may not be included. An end of the solder flow slowing apparatus 10 may be partially or entirely folded to be hooked on the jet nozzle 20.

As described above, the solder flow slowing apparatus 10 of this embodiment includes the upper slope 11 (an example of the slope portion). The upper slope 11 is disposed adjacent to an outlet of the ejection nozzle 20 and receives the molten solder 6 overflowing from the jet nozzle 20 that ejects the molten solder 6, and the molten solder 6 overflowing from the jet nozzle 20 flows toward the liquefied solder surface 6a of the molten solder in the solder bath 5 that recovers the molten solder 6.

In the foregoing embodiment, the solder flow slowing apparatus 10 includes one catchment 15. However, a number of the catchment 15 is not limited to one. In other words, the solder flow slowing apparatus 10 may include a plurality of the catchments 15. Moreover, in the foregoing embodiment, the step 12 includes a linearly upward slope. However, the step 12 may be in a form of steps like stairs.

In the foregoing embodiment, the upper slope 11 and the lower slope 13 are both linearly tilted. However, those slopes are not limited to a form that is linearly tilted. In other words, the upper slope 11 and the lower slope 13 may be tilted and bent in a thickness direction, or may be in a stair-like form.

Further, the solder flow slowing apparatus 10 may have a concave-convex processed surface on which the molten solder 6 flows. In such a case, convexities of the concave-convex processed surface serve as flow slowing blocks that reduce a speed of the molten solder 6.

More effects and modifications are easily created by a person skilled in the art. Therefore, broader embodiments of the invention are not limited by the specific description and the typical embodiment described above. Thus, the invention may be embodied in other forms without departing from the spirit or the scope of the general idea of the invention defined by the attached claims and equivalent thereof.

While the invention has been shown and described in detail, the foregoing description is in all aspects illustrative and not restrictive. It is therefore understood that numerous other modifications and variations can be devised without departing from the scope of the invention.

What is claimed is:

1. A soldering apparatus comprising:
a solder bath configured to hold molten solder;
an ejection nozzle that ejects the molten solder supplied from the solder bath; and
a solder flow slowing ramp that i) is disposed adjacent to an outlet of the ejection nozzle and receives the molten solder overflowing from the ejection nozzle, and ii) downwardly slopes toward a liquefied solder surface of the molten solder in the solder bath so as to return the molten solder overflowing from the ejection nozzle to the solder bath.

2. The soldering apparatus according to claim 1, wherein
a base end portion of the ramp is rotatably attached to the ejection nozzle and rotates about a rotation axis that is parallel to the liquefied solder surface of the molten solder in the solder bath, and
a tip end portion of the ramp is configured to float on the liquefied solder surface of the molten solder in the solder bath.

3. The soldering apparatus according to claim 2, wherein
a specific weight of a material from which the ramp is made is lighter than a specific weight of the molten solder.

4. The soldering apparatus according to claim 2, wherein
the tip end portion of the ramp is buoyant relative to the molten solder.

5. The soldering apparatus according to claim 1, further comprising:
a catchment that is provided at a midway position of the ramp to temporarily hold the molten solder.

6. The soldering apparatus according to claim 1, wherein the ramp includes:
a first inclined portion, a second inclined portion and a step between the first and second inclined portion, wherein
the first inclined portion extends downward from a base end portion of the ramp which is disposed adjacent to the ejection nozzle,
the step extends upward from a lower end of the first inclined portion, and
the second inclined portion extends downward from the step to a tip end portion of the ramp and is configured to float on the liquefied solder surface of the molten solder in the solder bath.
